(19) United States
(12) Patent Application Publication
(10) Pub. No.: US 2016/0017823 A1
(43) Pub. Date: Jan. 21, 2016

(54) SYSTEMS AND METHODS FOR REGULATING FUEL SYSTEMS

(71) Applicant: Agility Fuel Systems, Inc., Fontana, CA (US)

(72) Inventors: Todd Sloan, Kelowna (CA); Chris Forsberg, Kelowna (CA)

(21) Appl. No.: 14/723,837

(22) Filed: May 28, 2015

Related U.S. Application Data
(60) Provisional application No. 62/003,961, filed on May 28, 2014.

(51) Int. Cl. F02D 41/00; F02M 69/46; F02M 69/54

(52) U.S. Cl. CPC F02D 41/0027; F02M 69/54; F02M 69/462

(57) ABSTRACT

The invention provides systems and methods for regulating, monitoring and controlling fuel distribution in a fuel system. Some embodiments provide systems and methods for regulating fuel distribution in an alternative fuel system, such as a natural gas vehicle fuel system. The fuel distribution may be regulated mechanically, electronically, or a combination thereof. In some embodiments, the fuel distribution can be regulated by a regulator for high pressure operation with a bypass path for low pressure operation.

### CROSS-REFERENCE

This application claims priority to U.S. Provisional Patent Application Ser. No. 62/003,961 filed May 28, 2014, which is entirely incorporated herein by reference.

### BACKGROUND OF INVENTION

Safety and reliability requirements for alternative fuel systems for vehicles include considerations for monitoring and controlling on-board fuel supply. Handling of different fuels may impose different requirements on each fuel system. Challenges remain concerning safety, reliability and performance of fuel storage and delivery from natural gas and other alternative fuel tanks. Further, challenges remain concerning monitoring and controlling fuel systems.

### SUMMARY OF INVENTION

Recognized herein is the need for improved systems and methods for regulating fuel storage and delivery in a fuel system. The fuel system can be provided on board a vehicle. The invention provides systems and methods for regulating, monitoring and controlling fuel distribution in a fuel system. Some embodiments provide systems and methods for regulating fuel distribution in an alternative fuel system, such as a natural gas vehicle fuel system. The fuel distribution may be regulated mechanically, electronically, or a combination thereof. In some embodiments, the fuel distribution can be regulated by a regulator for high pressure operation with a bypass path for low pressure operation. Such a regulator-bypass assembly may be controlled or actuated mechanically, electronically, or a combination thereof.

Also recognized herein is the need for monitoring and controlling the fuel system (e.g., to compensate for various conditions, to communicate status, to communicate concern of leakage or service/maintenance, etc.). Different vehicles may utilize different sensors and gauge configurations. In some embodiments, a controller capable of assisting with monitoring and controlling of storage and delivery of a fuel (e.g., natural gas) can be provided. The controller can be configured to operate or communicate with various sensors and gauge configurations. For example, an electronic control unit (ECU) may be capable of communicating with various sensors, gauges, devices, controls and/or other ECUs of varying specifications. In some embodiments, the ECU may be capable of communicating with a flow component (e.g., a regulator-bypass assembly).

Aspects of the invention relate to a method for operating a fuel system on a vehicle. The method comprises providing the fuel system. The fuel system comprises a gaseous fuel containing device of the vehicle, and a fuel flow path from the gaseous fuel containing device to an engine of the vehicle. The fuel flow path is configured to deliver a fuel from the gaseous fuel containing device to the engine. The fuel flow path comprises a pressure regulator and an alternative fuel flow path for bypassing the pressure regulator. The method further comprises opening the alternative fuel flow path below a predetermined fuel pressure, thereby bypassing the pressure regulator.

The method can further comprise closing the alternative fuel flow path when the pressure of the fuel is above the predetermined fuel pressure. The method can further comprise alternately opening and closing the alternative fuel flow path, thereby switching between the pressure regulator and the alternative fuel flow path. The switching can be mechanically controlled. The switching can be electronically controlled. The switching can be controlled by an electronic control unit in communication with one or more sensors that measure the fuel pressure. The predetermined fuel pressure can be a predetermined inlet pressure of the fuel flowing to the pressure regulator. The alternative fuel flow path can comprise a valve or flow control component. The method can further comprise automatically opening the valve or flow control component below the predetermined inlet pressure. The method can further comprise mechanically actuating the opening of the alternative fuel flow path.

Aspects of the invention relate to a system for regulating gaseous fuel delivery on a vehicle. The system can comprise a container that holds a volume of gaseous fuel. The system can also comprise one or more fuel transfer lines that transfer at least a fraction of the volume of gaseous fuel from the container to a regulator bypass assembly comprising (1) a regulator flow path having a regulator and (2) a bypass flow path by passing the pressure regulator; and an actuator configured to variably control flow of gaseous fuel via the one or more fuel transfer lines through (1) the regulator flow path, (2) the bypass flow path, or (3) any combination thereof, based on one or more flow parameters while the vehicle is operating.

The actuator can sense the one or more flow parameters implicitly with a mechanical actuator that passively responds to the one or more flow parameters. The actuator can sense the one or more flow parameters based on a measurement from one or more sensors configured to measure the one or more flow parameters. The one or more flow parameters can include inlet pressure of fuel flowing to the pressure regulator.

Aspects of the invention relate to a method of switching a vehicle from a first operating state to a second operating state. The method can comprise providing a fuel system. The fuel system can comprise a gaseous fuel containing device of the vehicle. The fuel system can also comprise a fuel flow path from the gaseous fuel containing device to an engine of the vehicle, wherein the fuel flow path is configured to deliver a fuel from the gaseous fuel containing device to the engine, and wherein the fuel flow path comprises (1) a first fuel flow path configured to deliver fuel to the engine at or above a predetermined fuel pressure and (2) a second fuel flow path configured to deliver fuel to the engine below the predetermined fuel pressure. The method can further comprise delivering the fuel to the engine through either of the first fuel flow path or the second fuel flow path. The method can further comprise switching a flow of the fuel from the first fuel flow path to the second fuel flow path or vice versa while the vehicle is operating

The switching can be mechanically controlled. The switching can be electronically controlled. The switching can be controlled by an electronic control unit in communication with one or more sensors that measure the fuel pressure.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a schematic of a fuel system carried on board a vehicle.

FIG. 1B is a schematic of a fuel system.

FIG. 2A is a schematic of a system comprising a fuel system and an engine on board a vehicle.

FIGS. 2B and 2C are schematic examples of fuel flow configurations in the system of FIG. 2A.

FIG. 3 shows an example of an electronic control unit (ECU).

FIG. 4 shows an example of an ECU within a vehicle.

FIG. 5 shows examples of entities in communication with an ECU.

### DETAILED DESCRIPTION OF INVENTION

The invention provides systems and methods for regulating, monitoring and controlling fuel distribution in a fuel system. In some embodiments, the invention provides systems and methods for regulating fuel distribution in a fuel system, such as a gaseous fuel (e.g., natural gas) vehicle fuel system. Various aspects of the invention described herein may be applied to any of the particular applications set forth below or in any other type of fuel storage/delivery setting. The invention may be applied as a standalone method or system, or as part of an integrated fuel storage/delivery system. It shall be understood that different aspects of the invention can be appreciated individually, collectively, or in combination with each other.

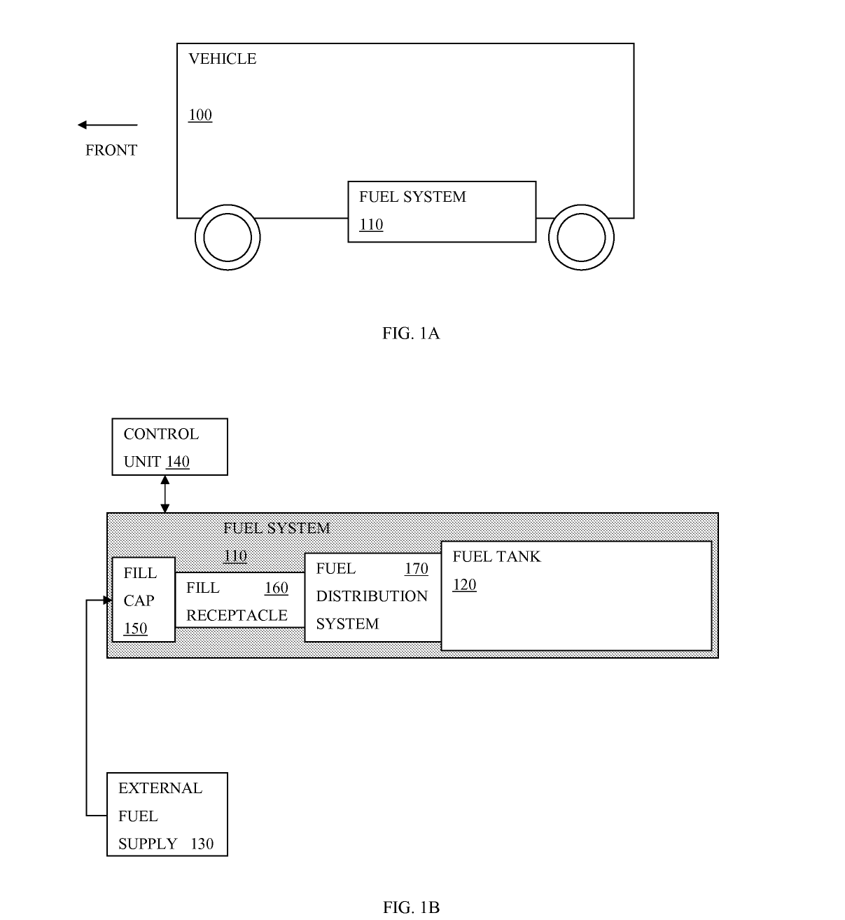

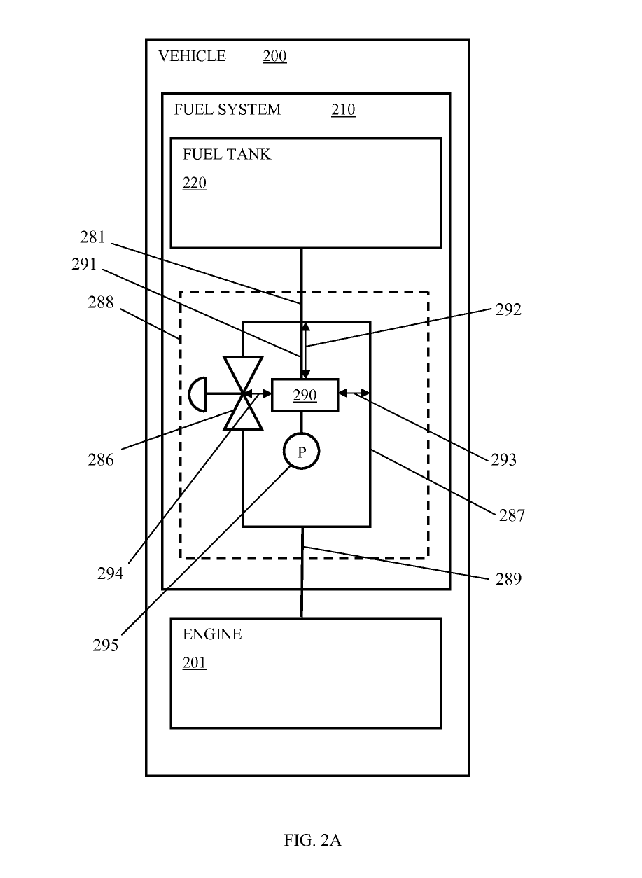

FIG. 1A is a schematic of a vehicle 100 with a fuel system 110 mounted thereon. A vehicle 100 may be any type of vehicle known in the art. A vehicle may be a truck, such as a light duty truck (e.g., class 1, class 2 or class 3), medium duty truck (e.g., class 4, class 5 or class 6), or heavy-duty truck (e.g., class 7 or class 8). In some embodiments, the vehicles may be cars, wagons, vans, buses, high-occupancy vehicles, dump trucks, tractor trailer trucks, transit, refuse or heavy-duty vehicles, or any other vehicles. The vehicle may have any weight. For example, the vehicle may weigh more than or equal to about 5000 lbs, 7,500 lbs, 10,000 lbs, 12,500 lbs, 15,000 lbs, 17,500 lbs, 20,000 lbs, 22,500 lbs, 25,000 lbs, 30,000 lbs, 35,000 lbs, 40,000 lbs, 45,000 lbs, 50,000 lbs, 55,000 lbs, 60,000 lbs, 65,000 lbs, 70,000 lbs, 75,000 lbs, or 80,000 lbs.

The fuel system 110 may be mounted to the vehicle in various configurations. For example, in a side mount configuration, a fuel system 110 may be installed on the side of the vehicle frame rail (not shown). Fuel systems may be installed on one or both sides of the vehicle, providing, for example, standard fuel capacities, measured in diesel gallon equivalents (DGE), of 40 DGE, 60 DGE or 80 DGE. In another example, in a behind-the-cab configuration, a fuel system 110 may be installed behind the cab on the vehicle frame rail, providing, for example, standard fuel capacities of 45 DGE, 60 DGE, 75 DGE, 100 DGE, 120 DGE, or 160 DGE. In a further example, in a roof mount configuration, a fuel system 110 may be installed on the roof of the vehicle body or in a custom integration, providing a wide range of customizable fuel capacities. In an additional example, in a front-of-the-body configuration, a fuel system 110 may be installed in front of the vehicle body, providing, for example, standard fuel capacities of 50-100 DGE.

A vehicle 100 may be propelled by a fuel, including, but not limited to, compressed natural gas (CNG), liquefied natural gas (LNG), liquefied petroleum gas (LPG), propane, butane, dimethyl ether (DME), methanol, ethanol, butanol, Fischer-Tropsch (FT) fuels, hydrogen or hydrogen-based gas, hythane, HCNG, syngas and/or other alternative fuels or fuel blends. For example, natural gas in the form of CNG or LNG may be an alternative fuel of choice for transit, refuse, and many other heavy-duty vehicles.

The fuel may be stored as a compressed gas, as a liquefied gas or as a liquid under its own vapor pressure. The fuel may be stored in the on-board fuel system 110, comprising a fuel tank, vessel, or any other type of device capable of containing a fuel in compressed gas, liquefied gas or liquid form. Any description of a fuel tank herein may also be applied to other types of fuel containing devices (e.g., a gaseous fuel containing device), and vice versa. For example, the gaseous fuel containing devices may be a tank, container, or vessel. The gaseous fuel containing device can hold a volume of gaseous fuel. The gaseous fuel containing device may be capable of containing a gaseous fuel, such as natural gas, therein. Any reference to gaseous fuel may include natural gas. Any aspects of the disclosure described in relation to gaseous fuel may equally apply to fuel in compressed gas, liquefied gas or liquid form at least in some configurations.

The fuel tank may be configured in accordance with the chosen fuel storage mode. For example, compressed gases, such as CNG, may require that the fuel tank be outfitted with adequate high pressure components (e.g., high pressure seals, relief valves, compression devices), wherein high-strength and lightweight materials may allow CNG pressures up to, for example, 3,600 psig or higher (e.g., up to at least about 4,000 psig, up to at least about 4,500 psig, up to at least about 5,000 psig, etc.). In another example, liquefied gases, such as LNG, may require that the fuel tank be outfitted with adequate liquefaction or vaporization components (e.g., coolers, liquid-vapor separators, insulation, vaporizers, heat exchangers, phase change materials, thermoelectric elements, etc.). LNG systems may operate at pressures of, for example, 0 psig, 50 psig, 100 psig, 150 psig, 200 psig, 250 psig, 300 psig, or 350 psig and temperatures of, for example, −259° F., −223° F., −200° F., −186° F., −175° F., −167° F., −158° F., or −150° F., requiring the use of cryogenic (about −260° F.) piping systems and vacuum-insulated storage tanks.

In some embodiments, a vehicle 100 may contain a single fuel tank. In other embodiments, the vehicle may contain a plurality of fuel tanks. The tanks may or may not have the same characteristics. The tanks may be mounted to any portion of the vehicle. In some embodiments, the tanks may be mounted to a side of the vehicle. One, two, or more tanks may be mounted on a single side of the vehicle, or on each side of the vehicle. The side-mounted tanks may at least partially protrude from a side surface of the vehicle.

The one or more fuel tanks may provide storage for a predetermined amount, or capacity, of fuel. For example, for natural gas measured in diesel/gasoline gallon equivalents (where 1 gasoline gallon equivalent (GGE)=standard cubic feet (SCF) of natural gas divided by 123, and 1 diesel gallon equivalent (DGE)=standard cubic feet (SCF) of natural gas divided by 139), the amount of fuel provided on board the vehicle may be, for example, up to about 28 DGE, 45 DGE, 52 DGE, 60 DGE, 63 DGE, 70 DGE, 75 DGE, 80 DGE, 88 DGE, 92 DGE, 140 DGE, 100 DGE, 105 DGE, 176 DGE, more than 176 DGE.

The fuel tank may have any size, shape and/or weight. For example, the fuel tank may be larger than, smaller than, or about the same size as a 5 gallon tank, 7 gallon tank, 10 gallon tank, 15 gallon tank, 20 gallon tank, 25 gallon tank, 30 gallon tank, 40 gallon tank, 50 gallon tank, or 70 gallon tank. The fuel tank may weigh more than, less than, or equal to about 0.01 tons, 0.03 tons, 0.05 tons, 0.07 tons, 0.1 tons, 0.2 tons, 0.3 tons, 0.5 tons, 0.7 tons, or 1.0 tons. For example, the fuel tanks may be of cylindrical form with dimensions (radius in inches×length in inches) of, for example, 25″×61″, 25″×80″, 25″×90″, 26″×80″, 26″×90″, 26″×120″, 26″×76″, 16″×80″, 21″×86″, 16″×120″, 21″×70″, 21″×86″, and one or more cylinders may be combined to achieve a predetermined total fuel capacity.

The fuel system 110 may be capable of containing a fuel at a predetermined pressure. For example, the fuel system 110 may be capable of containing a fuel having a pressure of less than or equal to about 10000 psig, 8000 psig, 7000 psig, 6500 psig, 6000 psig, 5500 psig, 5000 psig, 4750 psig, 4500 psig, 4250 psig, 4000 psig, 3750 psig, 3500 psig, 3250 psig, 3000 psig, 2750 psig, 2500 psig, 2000 psig, 1500 psig, 1000 psig, 500 psig, 300 psig, 100 psig, or less.

The fuel system 110 may have one or more fuel outputs. The fuel output may transfer the fuel to another part of the vehicle 100, such as an engine. In one example, the fuel may be output to mix with air in the cylinder of an engine. The fuel may be used in the process of propelling the vehicle. Further, the fuel system 110 may have one or more fuel inputs. The fuel inputs may transfer the fuel from an external fuel supply to another part of the vehicle 100, such as the one or more on-board fuel tanks.

FIG. 1B is a schematic of the fuel system 110. The fuel system 110 may comprise a fuel tank 120 into which fuel from an external fuel supply 130 is supplied. The fuel can be supplied through a fill cap 150 removably connected to a fill receptacle 160. In some embodiments, the fill receptacle 160 may be in communication with the fuel tank 120 via a fuel distribution system 170. The fuel system may further be in electronic communication with a control unit 140. The fuel system may be housed in a cover (not shown), which may be mounted to the vehicle, and may serve to contain and protect the fuel tank 120 and other fuel system components. The cover may be made of a variety of materials, including, but not limited to, metal or metal alloys (e.g., steel, iron, aluminum, titanium, copper, brass, nickel, silver, or any alloys or combinations thereof, composite materials (e.g., carbon fiber, fiberglass), or polymer materials. The cover may be made of a single material or may comprise multiple pieces made of different materials.

One or more fuel systems 110 may be provided on board the vehicle. Each fuel system may comprise one or more fuel tanks 120. In some cases, individual fuel tanks may have dedicated fuel system components (e.g., fill cap, fill receptacle and/or fuel distribution system). In some cases, multiple tanks may share one or more fuel system components. In some cases, each fuel tank may have a single inlet and a single outlet. The inlet and the outlet may or may not be the same. In some cases, each fuel tank may be accessed via multiple fuel system components (e.g., via multiple fill receptacles, or via multiple fuel distribution systems). For example, a vehicle having multiple fuel tanks may have multiple inlets and/or multiple outlets. The inlets and/or outlets may or may not be shared with other fuel tanks. Further, individual fuel tanks may or may not be in communication with (e.g., connected to) a fuel distribution system. For example, only a subset of the fuel tanks may be filled and/or emptied via a fuel distribution system. This configuration may be used, for example, when the fuel tanks are interconnected. For example, one (or a subset) of the fuel tanks may supply fuel to the engine via a fuel distribution system while being supplied with fuel from the remainder of the fuel tanks. The one or more fuel distribution systems on the engine-supplying tank(s) may be of a given type or configuration. The remainder of the fuel tanks may or may not have fuel distribution systems. For example, individual fuel tanks among the remaining fuel tanks may have the same type of fuel distribution system as the engine-supplying tank(s), different type(s) of fuel distribution system than the engine-supplying tank(s), or no fuel distribution system. In some cases, a subset of the tanks may have fuel distribution systems configured for tank-to-tank fuel distribution or supply. In some examples, such fuel distribution systems may be configured differently than engine-supplying fuel distribution systems. In some embodiments, tank-to-tank or other fuel distribution systems herein may be used to implement staged fuel delivery, as described in greater detail elsewhere herein.

The fuel system 110 may be used to provide fuel to the fuel tank 120. The fuel system 110 may also be used to provide fuel from the fuel tank 120 to, for example, the vehicle engine. Fuel to and/or from the fuel tank may be transferred using the fuel distribution system 170. The fuel distribution system 170 may comprise one or more flow transfer components, one or more flow conditioning components and/or one or more flow control components. For example, the flow distribution system 170 for CNG may comprise one, two, or more check valves at and/or downstream of the fill receptacle 160 along a gas (or fuel) flow path from the fill receptacle 170 to the fuel tank 120. The one or more check valves may ensure that gaseous fuel is transferred in one direction only (toward the fuel tank). In another example, the fuel distribution system 170 may comprise a regulator-bypass assembly. The regulator-bypass assembly may comprise a regulator with a bypass path. The regulator-bypass assembly may include a valve (e.g., a bypass valve for opening and closing the bypass path). In some implementations, a regulator portion of the regulator-bypass assembly may be used for high pressure operation and a bypass portion of the regulator-bypass assembly may be used for low pressure operation. Switching between the regulator and bypass portions may be controlled or actuated mechanically, electronically, or a combination thereof.

The fuel distribution system 170 may be rated at a predetermined pressure (e.g., 3600 psig) and may be required by law to include the one or more check valves. The gas may be transferred via standard gas flow components known in the art (e.g., standard stainless steel, brass or other suitable tubing, check valves, shutoff valves, solenoid valves, bleed valves, relief valves, pressure regulating valves, regulators, filters, etc.). Further, the fuel distribution system may or may not comprise a pressure manifold. The pressure manifold may include one or more gas inlets and/or outlets (e.g., from multiple fill receptacles, to multiple fuel tanks and/or engine manifold inlets), one or more bleed valves, one or more pressure transducers and/or additional flow components. In some embodiments, the fuel distribution system may comprise a fuel transfer line from the fill receptacle 160 to the fuel tank 120, and a fuel transfer line from the fuel tank 120 to the vehicle engine. The paths may or may not partially coincide, for example, by providing a single transfer flow path to the fuel tank and a tee connector or a 3-way valve to enable multiple transfer lines to feed fuel to and/or from the fuel tank.

The fuel distribution system 170 may further comprise a ¼ turn shutoff valve and/or other flow regulating device on one or more outlets from the pressure manifold and/or any transfer line regardless of the presence or absence of a pressure manifold. For example, a (manual) ¼ turn shutoff valve may be provided on the transfer line from the pressure manifold to the gas tank. In some embodiments, the fuel transfer line to the fuel tank may be bidirectional, i.e., the ¼ turn shutoff valve may allow flow in both directions. Alternatively, 3-way, 4-way or other valve types may be used.

One or more electronically-controlled shutoff valves, such as solenoid valves, may also be provided, for example, on the transfer line from the pressure manifold to the vehicle engine. Solenoid valves may be combined with other gas regulating valves, such as, for example, a pressure regulator downstream of the solenoid valve. For example, the transfer line to the vehicle engine (e.g., via the engine distribution manifold) may include a solenoid valve in series with a downstream pressure regulator. Further, fuel flow control in the regulator-bypass assembly, actuation of the regulator-bypass assembly, or a combination of fuel flow control and actuation may be achieved electronically and/or mechanically. For example, the regulator-bypass assembly may comprise one or more electronically controlled valves or flow control components. As described in greater detail elsewhere herein, the regulator-bypass assembly may comprise two (or more) portions configured for operation various operating conditions, user preferences, system conditions, or any combination thereof. For example, the regulator-bypass assembly may comprise a high pressure portion and a low pressure portion. Each portion may comprise individual flow components that are electronically and/or mechanically controlled. Further, switching between the portions may be electronically and/or mechanically controlled. In some embodiments, switching in the regulator-bypass assembly may be purely mechanical. In such cases, individual components of each flow path (e.g., high pressure and low pressure portions) may be mechanically controlled, electronically controlled, or a combination thereof. Thus, the regulator-bypass assembly may be implemented with varying proportion of mechanical and electrical control/actuation.

The one or more solenoid valves may or may not be in electronic communication with the control unit 140. In some embodiments, the one or more solenoid valves may be in electronic communication with one or more other control units provided on the vehicle. The control unit 140 or another control unit may provide an electronic signal to the solenoid valve. For example, the solenoid valve may remain in a closed position until power is provided by a control unit to activate (e.g., open) the solenoid valve. In some cases, a flow measurement device may be provided that may close the solenoid valve if the fuel flow rate exceeds a predetermined value. Such closure of the solenoid valve may be further communicated to one or more control units.

Any control unit provided on the vehicle may have capability to send an audible or visual control signal (e.g., an alarm sound, or alarm symbol on the vehicle drive board) to the operator of the vehicle. Furthermore, any control unit provided on the vehicle may have capability of automatically providing one or more control signals to one or more other vehicle systems. Control unit signals and/or system actuation may be automatic. In some cases, control unit signals may prompt the vehicle operator (i.e., driver) to provide an input. The vehicle may be configured to allow automatic control, manual user control and/or a combination thereof.

The fuel system 110 may include one or more filters. The filters may be provided on a fuel transfer line from the fill receptacle to the pressure manifold, on a fuel transfer line from the pressure manifold to the fuel tank, on a fuel transfer line from the pressure manifold to the engine, on a fuel transfer line from the fill receptacle directly to the fuel tank, on a fuel transfer line from the fuel tank to the engine, etc. Any filter known in the art, including coalescing filters, sieves, chemical adsorption and other inline filters, may be used.

In embodiments requiring cooling and/or insulation, such as in LNG fuel systems, the fuel system components may be appropriately outfitted with insulation, chillers and/or other components known in the art. For example, the fuel transfer lines and the fuel tank may be wound with insulation or protected with superinsulation. In some cases, the LNG fuel may be cooled at a (filling) station and then transferred to the vehicle fuel tank where it is kept cold only with insulation. For fuel delivery to the engine, vapor pressure may be built up in the tank and/or the liquid LNG may be passed through a vaporizer to the engine.

The control unit 140 may comprise one or more electronic control circuits, such as, for example, a control circuit comprising a wire (e.g., a kill cap control circuit between the fill cap 150 and the control unit 140), or a control circuit comprising one or more indicators (e.g., an actuators, a trigger, a magnet) and one or more indicator receivers (e.g., a reed sensor). For example, one or more kill caps may be provided. If one or more specified operational conditions are detected, a starter interrupt circuit may prevent a vehicle from being started. The control unit 140 may be an electronic control unit (ECU). The control unit 140 may actuate, electronically communicate with or otherwise control other systems on board the vehicle (e.g., a vehicle ignition system). In some embodiments, the control unit 140 may provide one or more control signals to the other vehicle systems (e.g., based on a signal or a processing operation performed by the control unit). For example, the ECU can start (e.g., connect) one or more systems on board the vehicle, stop (e.g., disconnect) one or more systems on board the vehicle, control or actuate (e.g., continuously) one or more systems on board the vehicle, etc.

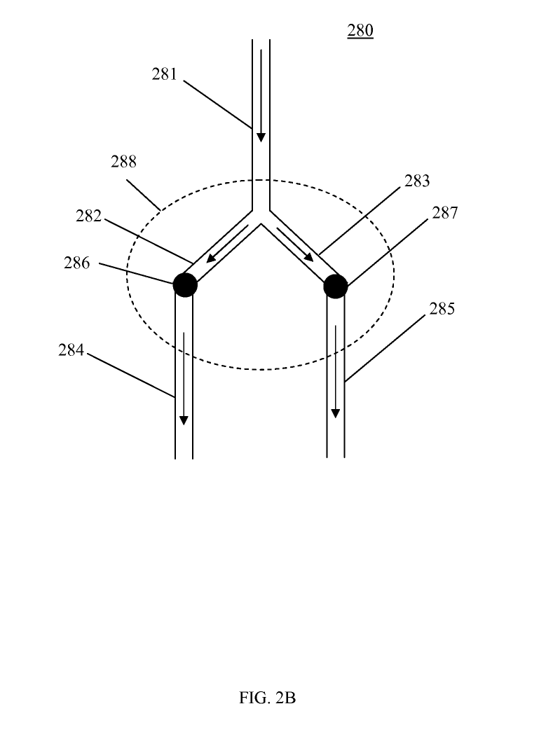

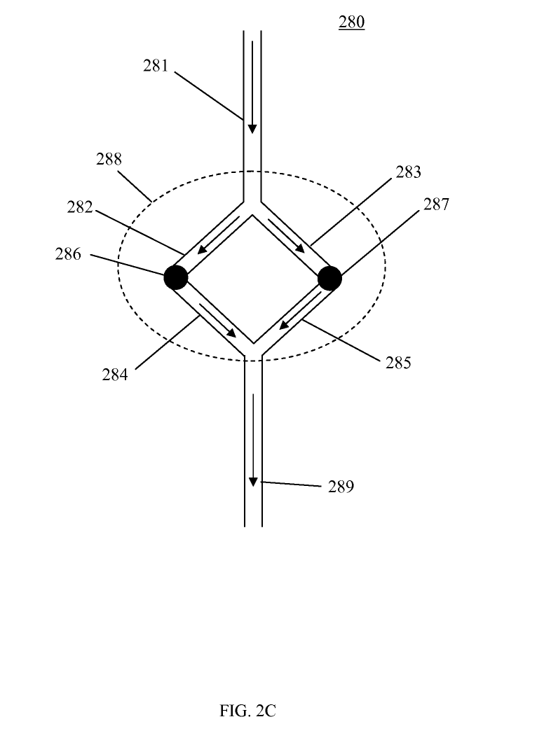

FIG. 2A is a schematic of a system comprising a fuel system 210 and an engine 201 on board a vehicle 200. The fuel system may comprise a fuel tank 220. The fuel system 210 may comprise a regulator-bypass assembly 288. The regulator-bypass assembly may be used for different purposes within the fuel system. For example, the fuel system may comprise multiple regulator-bypass assemblies (e.g., between individual fuel tanks, between one or more fuel tanks and the engine, etc.). In some embodiments, the fuel tank 220 may supply the engine 201 with fuel via the regulator-bypass assembly 288. The fuel system 210 may comprise a fuel distribution system (not shown). In some cases, the regulator-bypass assembly 288 may be provided as part of the fuel distribution system. In some cases, the regulator-bypass assembly 288 may be provided separately from the fuel distribution system (e.g., elsewhere within the fuel system 210). In yet other cases, the regulator-bypass assembly 288 may be provided separately from the fuel system 210 (e.g., on board the vehicle, as part of an engine assembly, etc.).

The fuel tank 220 may be in fluid communication with the regulator-bypass assembly 288 via a fuel connection 281. The fuel tank can be a container. The regulator-bypass assembly 288 may be in fluid communication with the engine 201 via a fuel connection 289. The fuel connections or lines 281 and 289 may comprise any fuel (or other fluid) flow components described herein, such as, for example, stainless steel, brass or other suitable tubing, check valves, shutoff valves, solenoid valves, bleed valves, relief valves, pressure regulating valves, regulators, bypass valves, filters, and/or additional flow components. Further, the fuel connections may comprise one or more pressure transducers, pressure gauges, thermocouples, or other sensors.

The regulator-bypass assembly 288 may comprise a regulator 286. The regulator 286 may be a pressure regulator, a mass flow controller, or any other flow control components known in the art. For example, the regulator can comprise a restricting element (e.g., a valve that can provide a variable restriction to the flow, such as a globe valve, butterfly valve, poppet valve, etc.), a loading element (e.g., a part that can apply force/loading to the restricting element, such as, for example, a weight, a spring, a piston actuator, a diaphragm actuator in combination with a spring, a pneumatic actuator, an electronically controlled actuator or motor, etc.), and a measuring element (e.g., diaphragm, mass flow meter, pressure sensor, temperature sensor, etc.). Further, the regulator-bypass assembly 288 may comprise a bypass 287. In some cases, the bypass 287 may comprise a bypass valve. The bypass can be an alternative fuel flow path. The bypass can lead to an unrestricted fuel flow path. In some cases, a valve may be provided separately from the bypass 287.

An actuator 290 may be used to control fuel flow in the regulator-bypass assembly 288. In some embodiments, the actuator may actuate 292 a valve (not shown) located in the fuel connection 281 (e.g., at a junction between the regulator 286 and the bypass 287). The valve may be used, for example, to switch between the regulator 286 and bypass 287 portions of the regulator-bypass assembly 288. In some embodiments, the actuator may actuate 293 the bypass 287. For example, the bypass may comprise a bypass valve. The bypass valve may be actuated by the actuator 290. For example, the actuator may open or close the bypass valve. In some embodiments, the actuator may actuate 294 the regulator 286. The regulator may be controlled by other actuator means in addition to, or in place of, the actuator 290. For example, the regulator may be actuated separately from the actuator 290, while the switching between the regulator 286 and the bypass 287 is controlled using the actuator (or controller) 290. In another example, the regulator may comprise a shutoff valve controlled by the actuator/controller 290, while fuel flow regulation is controlled by another actuator/controller. In some cases, the actuator 290 may communicate with one or more other actuators or controllers (e.g., the actuator/controller 290 may send a signal to another actuator/controller to begin, pause or end an action). The actuator 290 may simultaneously actuate one or more other components of the regulator-bypass assembly (e.g., the actuator may simultaneously or sequentially perform one or more of the actuations 292, 293 and 294). For example, the actuator 290 may close a valve in the regulator or at the junction between the regulator and the bypass, as well as open the bypass. Alternatively, the actuator 290 may simply open the bypass in order to affect fuel flow through the bypass path instead of the regulator (e.g., when the bypass path is opened, fuel may flow partially or fully through the bypass path due to lower fuel restriction and pressure drop).

The actuator 290 may be in fluid communication with at least one of fuel paths (also “fuel flow paths” or “flow paths” herein) 281, 289, 286, 287 and 291. The actuator may be in fluid communication with the fuel path(s) at the point(s) of actuation and/or at other location(s). The actuator may be in fluid communication with the fuel path(s) in order to sense a fuel flow parameter. For example, the actuator may be a mechanical spring that is actuated by fuel pressure (e.g., thereby opening or closing a bypass valve). Other mechanical actuation configurations may include, for example, gears or translation stages, pneumatic actuation (e.g., fuel pressure force may compress a hydraulic fluid that actuates a bypass valve, magnetic actuation (e.g., fuel pressure force may move a magnetic component in proximity of a mating magnetic component until the components experience a sufficient magnetic attraction force to engage mechanically, thereby opening or closing a valve), etc. In some cases, the actuator may comprise a sensor 295, such as, for example, a pressure sensor. In some cases, the actuator may not comprise the sensor 295 but may sense the parameter implicitly (e.g., a spring loading may change as a result of changing fuel pressure force). Sensors, such as the sensor 295, may be provided as part of the actuator 290 or anywhere elsewhere within the regulator-bypass assembly (e.g., separately from the actuator 290). In some cases, such sensors may communicate with one or more actuators or control units (e.g., an ECU).

FIGS. 2B and 2C are schematic examples of fuel flow configurations 280 in the system of FIG. 2A. Fuel may be supplied to the regulator-bypass assembly (e.g., from a fuel tank) via the fuel inlet 281. The fuel inlet 281 may comprise a single fuel line that splits into separate fuel lines 282 and 283 to the regulator 286 and to the bypass 287, respectively. Alternatively, the fuel lines 282 and 283 may be configured as separate inlets to the regulator 286 and to the bypass 287, respectively (not shown). In the configuration in FIG. 2B, separate fuel outlets 284 and 285 may be provided from the regulator 286 and from the bypass 287, respectively. Alternatively, as shown in FIG. 2C, separate fuel lines 284 and 285 from the regulator 286 and from the bypass 287, respectively, may join into a single fuel line that constitutes a fuel outlet 289. Further, as previously described, one or more valves, actuators, sensors, or other flow, control or measurement components may also be provided in the fuel lines 281, 282, 283, 284, 285 and 289, in the regulator 286 and/or in the bypass 287. For example, the bypass 287 may comprise a bypass valve. In this configuration, the bypass 287 may not be used for changing or regulating pressure. Alternatively, or in addition to the bypass valve, the bypass 287 may comprise a fuel flow restriction, such as, for example, a regulator. Thus, the regulator-bypass assembly may comprise a primary regulator bypassed with another regulator (e.g., another regulator with a spring). For example, the bypass 287 may also be a regulator, or be part of the same regulator 286. In some embodiments, the bypass 287 may be implemented on the (primary) regulator 286 (e.g., connected directly to the primary regulator, built within the regulator, built as an external add-on to the regulator, etc.). Thus, the regulator 286 and the bypass 287 may be the same component. Switching between the regulator 286 and bypass 287 paths inside of the regulator (or regulator-bypass assembly) may be implemented using various mechanical and/or electrical switch mechanisms. Alternatively, the bypass 287 may not comprise a fuel flow restriction.

In some embodiments, the fuel flow configurations 280 may advantageously be used to enable fuel paths suitable for different operating conditions, user settings (e.g., mileage or fuel efficiency requirement, frequency of refueling, operation at low fuel pressures, etc.), or other parameters. Such alternate fuel paths may be implemented automatically (e.g., mechanically), manually (e.g., by a user), or a combination thereof. In some embodiments, the alternate fuel paths may be implemented electronically (e.g., by an ECU). Electronic implementation may be affected automatically (e.g., as determined by the ECU without user input), or in combination with user input (e.g., based on user input to the ECU). Further, fuel flow configurations and settings may be communicated (e.g., via the ECU) to one or more gauges (e.g., vehicle dashboard) of the disclosure. Further, such communications may include inputs from one or more sensors, as described in greater detail elsewhere herein.

The fuel flow configurations 280 may be used, for example, to implement two or more fuel paths from the fuel tank 220 to the engine 201. For example, a first fuel path may be suitable when fuel pressure at various points in the fuel system 210 is above a given value. A first fuel path may be suitable, for example, when the fuel pressures in the fuel tank 220 and/or upstream of the regulator-bypass assembly (e.g., in the fuel lines, 281, 282 and/or 283) are above given values. A second fuel path may be suitable, for example, when the fuel pressures in the fuel tank 220 and/or upstream of the regulator-bypass assembly (e.g., in the fuel lines, 281, 282 and/or 283) are below given values.

In some embodiments, the first and second fuel paths may be implemented in the regulator-bypass assembly 288 by switching between the regulator 286 and the bypass 287. The switch may be implemented by turning the bypass 287 on or off. In some cases, the switch may be mechanically controlled or actuated. For example, the switch may be spring-loaded, wherein the spring may turn the bypass 287 on or off (e.g., the spring may mechanically open or close a bypass valve). In some cases, the switch may be electronically controlled or actuated. For example, a solenoid valve may be used to turn the bypass 287 on or off (e.g., the bypass may comprise a solenoid valve or other electronically controlled valve). Embodiments of the invention allow for alternate fuel paths to be implemented based on local fuel flow conditions, based on fuel flow conditions anywhere else within the fuel system 210, or based on any other parameter associated with the vehicle 200 or provided by its user (e.g., driver). Such parameters may be communicated manually and/or automatically using mechanical and/or electronic communication systems. The parameters may include, but are not limited to, pressure, temperature, mass flow rate, fault condition or alarm, vehicle condition, driver preferences, or other factors or parameters.

The first fuel path may comprise, for example, the inlet fuel lines 281 and/or 282, the regulator 286, and the outlet fuel lines 284 and/or 289. The second fuel path may comprise, for example, the inlet fuel lines 281 and/or 283, the bypass 287, and the outlet fuel lines 285 and/or 289. The first fuel path may be used when the fuel inlet pressure (e.g., upstream of the regulator 286, upstream of the bypass 287, in the fuel lines 282, 283 and/or 281, etc.) is above a threshold pressure (e.g., about 210, 230 or 250 psig or psia). The second fuel path may be used (e.g., to bypass the first path) when the fuel inlet pressure (e.g., upstream of the regulator 286, upstream of the bypass 287, in the fuel lines 282, 283 and/or 281, etc.) is below a threshold pressure (e.g., 210 psig or psia). In some cases, the bypass 287 may be closed (e.g., when the first fuel path is implemented). In some cases, the regulator 286 may be closed or have limited or no fuel flowing through it (e.g., when the second fuel path is implemented). In some cases, one or more fuel lines (or fuel system or engine components) downstream of the regulator-bypass assembly may be configured or suitable for operation under certain operating conditions (e.g., within a given range of pressures, such as, for example, pressures associated with the first or second fuel paths). Thus, as shown in FIG. 2B, it may be advantageous to keep the bypass outlet fuel line 285 (e.g., configured for low pressure operation) separate from the regulator outlet fuel line 284 (e.g., configured for high pressure operation).

The threshold pressure (gauge or absolute) may be less than about 100 psi, 125 psi, 150 psi, 175 psi, 200 psi, 205 psi, 210 psi, 215 psi, 220 psi, 225 psi, 250 psi, 275 psi, 300 psi, 325 psi, 350 psi, 400 psi, 450 psi, 500 psi, 550 psi, 600 psi, 650 psi, 700 psi, 750 psi, 800 psi, 850 psi, 900 psi, 950 psi, 1000 psi, 1100 psi, 1200 psi, 1300 psi, 1400 psi, 1500 psi, 1750 psi, 2000 psi, 2250 psi, 2500 psi, 2750 psi or 3000 psi, and the like. In some embodiments, the threshold pressure (gauge or absolute) can be about 100 psi, 125 psi, 150 psi, 175 psi, 200 psi, 205 psi, 210 psi, 215 psi, 220 psi, 225 psi, 250 psi, 275 psi, 300 psi, 325 psi, 350 psi, 400 psi, 450 psi, 500 psi, 550 psi, 600 psi, 650 psi, 700 psi, 750 psi, 800 psi, 850 psi, 900 psi, 950 psi, 1000 psi, or more. In some cases, the switching mechanism and/or the regulator(s) may be configured for operation above a given pressure. For example, the switching mechanism and/or the regulator 286 may be configured for operating pressures of at least about the threshold pressure, while the bypass 287 may be configured for operating pressures of less than about the threshold pressure.

The fuel flow configurations and switchable fuel paths of the disclosure may be implemented for any alternative fuel systems described herein, including fuels such as, for example, CNG, LNG, hydrogen, propane, butane or LPG, etc. In some embodiments, the systems and methods described herein may improve safety and life of the vehicle and/or the vehicle fuel system. Further, the systems and methods described herein may result in gains in vehicle driving range. For example, use of switchable fuel paths for high and low pressure operation (e.g., using the regulator-bypass assemblies of the disclosure) may result in a gain of 150 psi (e.g., about 4-5% out of 3600 psi) in accessible on-board fuel capacity. In some cases, this may result in an increase in the driving range of the vehicle. For example, about 20 miles of extra driving range per single fill may be achieved. In some examples, a gain in accessible on-board fuel capacity of at least about 10 psi, 30 psi, 50 psi, 75 psi, 100 psi, 125 psi, 150 psi, 200 psi, 250 psi, 300 psi, 350 psi, 400 psi, 450 psi, 500 psi, 750 psi, or 1000 psi may be achieved. In some examples, a gain in accessible on-board fuel capacity of at least about 0.5%, 1%, 1.5%, 2%, 2.5%, 3%, 3.5%, 4%, 4.5%, 5%, 5.5%, 6%, 7%, 8%, 9%, 10%, 15%, or 20% of total fuel capacity (e.g., the actual or theoretical mass, volume or pressure of fuel in the vehicle's the fuel tank(s), such as, for example, 3600 psia or psig) may be achieved. In some examples, an increase in driving range of at least about 1 mile, 2 miles, 5 miles, 10 miles, 15 miles, 20 miles, 25 miles, 50 miles, 75 miles, or 100 miles (extra) per single fill may be achieved.

Additional fuel paths (e.g., in the fuel system 210 and/or in the regulator-bypass assembly 288) may also be implemented. In such examples, two or more threshold pressures may exist. Further, each alternative path may have its own pressure level or other parameters (e.g., measured pressure, measured temperature, fuel level, fault detection, derived or calculated parameters etc.). For example, fuel paths configured for operation at different operating conditions or under different circumstances may comprise different sensors (e.g., dynamic temperature sensors may be used on a high pressure fuel path but not on a low pressure fuel path, a low pressure fuel path may comprise fewer sensors that are more sparsely distributed along the fuel path, etc.), be monitored using different gauges and/or interfaces (e.g., low pressure operation may be monitored using a simple user interface, while for high pressure operation, information and control signals may be provided in greater detail to a user and/or displayed or processed via several user interfaces or gauges), have different parameters, settings and/or procedures associated with them (e.g., sensor data received for a high pressure fuel path may be processed using a different algorithm than sensor data received for a low pressure fuel path), or any combination thereof. A plurality of fuel paths may be used to provide more gradation (e.g., each fuel path may be configured for a narrower set of conditions or settings). Implementation of a plurality of fuel paths may be used to further improve system and vehicle performance. Further, mechanically and/or electronically actuated switchable flow paths may be implemented anywhere within the fuel system 210 or on the vehicle 200. Any aspects of the disclosure described in relation to switchable and/or alternate flow paths in regulator-bypass assemblies may equally apply to switchable and/or alternate flow paths elsewhere within the fuel system 210 or on the vehicle 200 at least in some configurations (and vice versa).

Embodiments of the invention may provide an alternate fuel path for lower pressure operation. As described in greater detail throughout the disclosure, the gaseous fuel containing device may contain fuel stored at a high pressure, and may provide the pressurized fuel to a vehicle engine. As fuel is provided to the engine, fuel in the gaseous fuel containing device is consumed and the fuel pressure drops. In some cases, such as, for example, when the high pressure system gets to about 2× or 3× the minimum operating pressure (wherein the minimum operating pressure may be the pressure required to ensure adequate fuel flow from the gaseous fuel containing device to the engine), starting and/or operating issues may occur. The starting and/or operating issues may be due to designing the fuel path to the engine for high pressure operation. Thus, there is a need to have a separate fuel path for low pressure operation.

The fuel path during low pressure operation may be specifically designed to deliver adequate fuel flow to the engine when the pressure (or amount) of fuel in the gaseous fuel containing device (e.g., tank) decreases to a predetermined value. For example, the low pressure fuel path can be designed for <750 psi operation. The components of the low pressure fuel path may or may not be designed for high pressure operation (e.g., 3600+ psi operation). For example, the low pressure fuel path may be able to withstand high fuel pressure. Alternatively, the low pressure fuel path may not be able to withstand high fuel pressure, and may only be operated when the pressure in the fuel tank (and the remainder of the fuel system) falls below a certain threshold value. In some examples, only a portion of each flow path (e.g., a regulating portion, described next) may be specifically designed for low pressure operation, while the rest of the fuel path may be identical during both low and high pressure operation. In other examples, one or more parallel or switchable flow paths may be provided along the fuel flow path (e.g., along a portion of the fuel flow path, along the entire fuel flow path, etc.).

In one example, a low pressure fuel path may be provided by placing two regulators, of which one is a high pressure regulator and one is a low pressure regulator, in parallel with each other. The high and low pressure flow paths may be outfitted with electronic solenoid valves and/or pressure sensors before, after, or both before and after each regulator. When the system pressure gets below a certain threshold, the system may route the fuel to the low pressure path. By enabling lower adequate fuel flow to the engine at lower fuel system pressures, vehicle operation before the next refueling may be extended through improved utilization of fuel carried on board the vehicle (i.e., more fuel can be extracted from the tanks since the fuel can continue being extracted down to lower tank pressures). Various combinations or alternative configurations of the above components or of similar components in the art may be used to implement the two paths.

Further alternative embodiments of the low pressure fuel path may include outfitting the high pressure fuel path (e.g., a first tank outlet, such as a first outlet of a tee connector) with a valve or other flow control component that automatically closes below a predetermined inlet pressure. The low pressure fuel path (e.g., a second tank outlet, such as a second outlet of a tee connector) may be outfitted with a valve (e.g., reverse acting valve) or flow control component of opposite functionality, i.e., that automatically opens below a predetermined inlet pressure. In this configuration, the alternate fuel paths may or may not be controlled by the ECU. For example, the valves or flow control components may be configured to mechanically switch between the high pressure fuel path and the low pressure fuel path. Individual valves and/or flow control components may be operated independently from the ECU. Alternatively, individual valves and/or flow control components may be electronically controlled by the ECU (e.g., automatically controlled or user-controlled). In some cases, individual valves and/or flow control components may be electronically controlled through the ECU as well as mechanically controlled (e.g., automatically controlled or user-controlled). For example, the regulator 286 (e.g., high pressure path) may be bypassed mechanically instead of by using an electronic signal. In this configuration, a method may be implemented which comprises opening an alternative flow path (e.g., low pressure path comprising the bypass 287). The alternative flow path may open below a predetermined inlet pressure, thereby bypassing the primary pressure regulator. The alternative flow path may be outfitted with a valve or flow control component that automatically opens below the predetermined inlet pressure. The low pressure and/or high pressure flow paths may or may not be mechanical in nature, and may or may not be controlled by the ECU. In some implementations, high pressure operation may place different flow regulation and/or control requirements on a flow path than low pressure regulation. In some examples, more extensive flow regulation and/or control may be needed for high pressure operation. In some examples, different flow regulation and/or control components may be used for high pressure and low pressure operation (e.g., components suitable for different pressure ranges). Any aspects of the disclosure described in relation to operation and system configuration as a function of pressure may equally apply to operation and system configuration as a function of alternative parameter(s) (e.g., mass flow rate) at least in some configurations.

In some embodiments, fuel flow may be controlled or regulated (e.g., in regulators, in switchable and/or alternate flow paths, regulator-bypass assemblies, or anywhere within the fuel system) by flow control devices such as, for example, an orifice, a venturi, or other flow control or throttling device. Such devices may restrict fuel flow (e.g., due to back pressure provided by the device). Further, flow rate, fuel (flow) pressure and/or fuel (flow) temperature may be controlled or regulated (e.g., in regulators, in switchable and/or alternate flow paths, regulator-bypass assemblies, or anywhere within the fuel system) using a turbine or other device that can extract energy from fuel stream (e.g., a high pressure stream). For example, flow rate, flow pressure and/or flow temperature may be reduced by including the turbine in the fuel flow path. In some examples, only a portion of the fuel flow may be passed through the turbine (or other power-producing device). Thus, flow splitting may provide additional fine-tuning in flow control and regulation. In one example, flow may be split between a first path that does not comprise a flow control and/or power-producing device, and a second path that does comprise a flow control and/or power-producing device. In another example, flow may be split between a first path that comprises a first type of flow control and/or power-producing device and a second path that comprises a second type of flow control and/or power-producing device (e.g., the two paths may comprise turbines configured for operation at different pressure drops and/or different mass flow rates). In some cases, the splitting may be configured to provide a set of given fuel flow parameters (e.g., fuel flow rate, fuel pressure, fuel temperature, etc.) in the fuel system. In some cases, the splitting may be configured to provide a given power production. In some cases, the splitting may be configured (e.g., optimized by the ECU) to provide a given combination of fuel flow parameters and power production. The energy extracted from the fuel flow may be used for different purposes on board the vehicle or in the fuel system (e.g., transformed from mechanical to electrical energy and used to power the ECU or various auxiliary devices such as a compressor or an air conditioning unit, transformed to electrical energy and stored in an energy storage device such as a battery or a capacitor, stored as mechanical energy in an energy storage device such as a flywheel, mechanically coupled to the drivetrain, etc.).

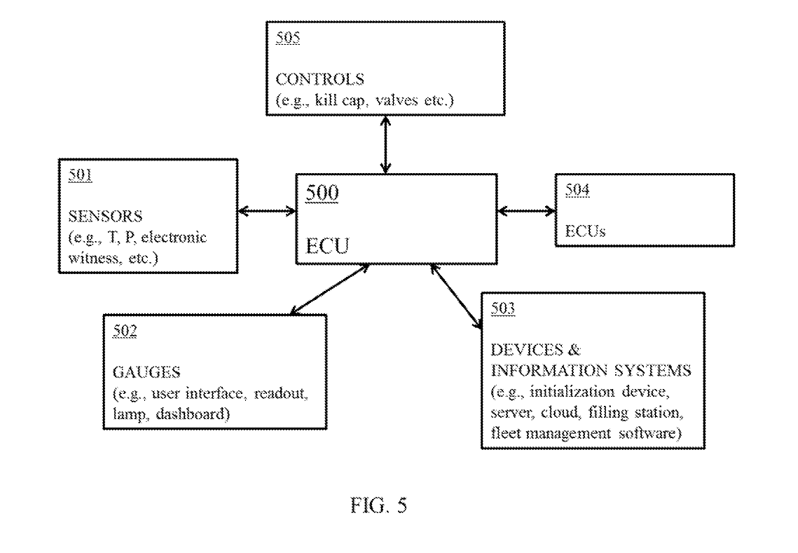

Systems of the disclosure (e.g., the system of FIG. 2A) may be following instructions provided by the ECU. For example, the ECU may receive temperature, pressure and/or other sensor data and may provide a signal to the one or more solenoid valves to open or close to control (e.g., close or open) appropriate fuel paths. Further, status and/or configuration of the fuel paths may be displayed by a gauge (e.g., vehicle dashboard). Further, the ECU may display other system parameters (e.g., fuel level, remaining driving range, fault conditions, etc.) which may be relevant to the fuel paths. As described in greater detail elsewhere herein (e.g., in relation to FIG. 5), the ECU may communicate with various entities. Data, control signals and/or parameters resulting from such communications may be used for controlling the fuel flow paths, and vice versa. For example, a fault condition or a signal received from a filling station may be used for deciding which fuel flow path the system should use.

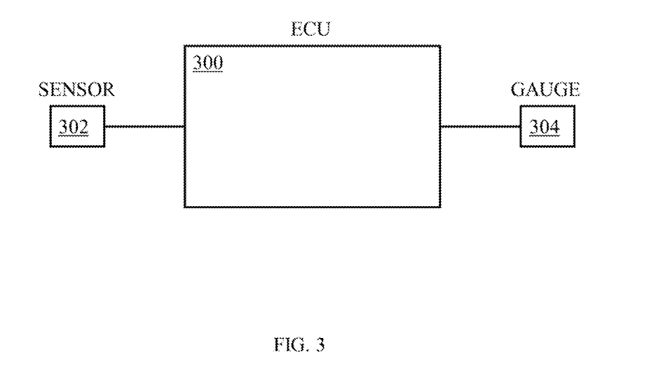

FIG. 3 shows an example of an ECU 300 in accordance with an embodiment of the invention. The ECU may be in communication with one or more sensors 302 and one or more gauges 304. A sensor 302 may be in communication with a gaseous fuel containing device, vehicle system and/or a local environment. The sensor may be a pressure sensor, temperature sensor, accelerometer, optical sensor, shock sensor, damage sensor, acoustic sensor, or any other type of sensor. Examples of types of pressure sensors may include a piezoresistive strain gauge, capacitive pressure sensor, electromagnetic pressure sensor, piezoelectric pressure sensor, optical pressure sensor, potentiometric pressure sensor, resonant pressure sensor, thermal pressure sensor, and/or ionization pressure sensor. In some embodiments, the pressure sensors may have ratiometric voltage output of about 0 to 5 volts. Examples of temperature sensors may include a variable resistance sensor, thermocouple, thermometer, or any other temperature sensor. In some embodiments, the temperature sensors may have ratiometric voltage output of about 0 to 5 volts. In some embodiments, a transducer may be provided (e.g., for pressure and temperature) that may provide an electronic signal to the ECU. In some embodiments, a plurality of sensors may be in communication with the ECU. The plurality of sensors may be the same type of sensors, or may include different types of sensors. For example, one or more temperature sensors and one or more pressure sensors may be in communication with the ECU.

One or more sensors 302 may be in communication with the ECU 300. The one or more sensors may be connected to the ECU. For example, the one or more sensor may be connected to the ECU via three or more lines (e.g., positive, negative, signal). When a plurality of sensors are integrated (e.g., pressure and temperature), positive and negative powers may be common. One or more voltage send lines may be provided (e.g., 5 volt send line), and one or more return data lines may be provided. In one example, a temperature sensor may be coupled to the ECU via three or more lines (e.g., +5 V, −5 V, signal) and may provide a signal on a data line indicative of the temperature of the natural gas in a gaseous fuel containing device, the temperature of the gaseous fuel containing device, the temperature of one or more plumbing lines, or the ambient temperature. In some instances, a separate sensor may be provided for ambient temperature. For example, a sensor on the ECU board, such as a chip temperature sensor may be provided. In an alternate embodiment, a sensor may communicate with the ECU wirelessly. The ECU 300 may receive one or more signals from the one or more sensors 302. The ECU may be responsive to the signals from the sensors, and may determine a command to send to a gauge 304. The command to the gauge may be indicative of a condition (e.g., amount of fuel remaining in the gaseous fuel containing device). The ECU may comprise one or more circuits that may filter one or more signals. For example, the ECU may comprise a circuit that may filter a received signal (e.g., from a sensor), or filter a signal that is to be output (e.g., to a gauge).

In some embodiments, a temperature sensor and/or pressure sensor may be capable of detecting or measuring the temperature and/or pressure of the gaseous fuel within the fuel containing device, the gaseous fuel containing device itself, or ambient conditions. In one example, the temperature sensor may detect a temperature within the gaseous fuel containing device, and the pressure sensor may detect a pressure within the gaseous fuel containing device. Further, a flow sensor may be capable of detecting or measuring the flow (e.g., flow rate) of the gaseous fuel to, from or within the fuel containing device, or anywhere within the fuel system or engine (e.g., within the fuel distribution system, in fuel paths and transfer lines, etc.). Similarly, the temperature and/or pressure sensor may be provided anywhere within the fuel system or engine. The temperature, pressure and/or flow sensors 302 may be connected to the ECU 300 via wired connections. For example, the temperature sensor may be connected to the ECU via one, two, or more lines. The pressure sensor may be connected to the ECU via one, two, or more lines. The flow sensor may be connected to the ECU via one, two, or more lines. Any sensor, such as those described elsewhere herein, may be connected to the ECU via one, two, or more lines. Alternatively, one or more sensors, such as the temperature sensor, the pressure sensor and/or the flow sensor, may be connected to the ECU wirelessly.

The ECU 300 may be in communication with the gauge 304. The ECU may be connected to the gauge. For example, the ECU may be connected to the gauge via a line. In one example, a temperature sensor may be coupled to the ECU via two, three, or more lines and may provide a signal on a data line indicative of the temperature of the natural gas in a gaseous fuel containing device, the temperature of the gaseous fuel containing device, the temperature of one or more plumbing lines, or the ambient temperature. In an alternate embodiment, an ECU may communicate with the gauge wirelessly. Any type of gauge 304 may be utilized in accordance with embodiments of the invention. For example, a two coil air core gauge or other gauges known in the art may be used. For example, various gauges may be driven by the ECU.

In an example, the gauge may be capable of receiving a command from the ECU, and based on the command, displaying, for example, a fuel level or another system parameter or condition. The fuel level may be displayed via a rotating spindle, as a sliding needle, digitally, as an image, as an audio indicator, or any other visual or audio indicator. The fuel level may be displayed in volume measurements (e.g., gallons or liters remaining), percentages (e.g., 67% of fuel left), status (e.g., full, empty), fraction (e.g., ⅓ remaining), or any units (e.g., 5 out of 10 bars full).

The ECU may contain a printed circuit board with embedded (configurable) programmed logic. The ECU may contain memory. The memory may contain tangible computer readable media such as code, logic, instructions for performing one or more steps. These may include steps in accordance with one or more algorithm that may determine a condition based on received signals. One or more calculations may be performed based on received signals and/or stored data. For example, such calculations may utilize a gas law and take non-linearity of gas compressibility into account. In some alternate embodiments, a memory may store a look-up table that may include one or more gauge commands provided based on sensor input. Alternatively, no look-up table for gauge commands based on sensor input is provided. The ECU may contain one or more processors. The one or more processors may be microprocessors. The microprocessors may be useful to determine a command to be sent to the gauge depending on input received at the ECU. The microprocessors may perform one or more steps as dictated by non-transitory computer readable media stored in memory. A microcontroller and interface software may be provided. The interface software may run on the ECU or an initialization device.

The initialization device may be provided separately from the ECU. Alternatively, in some embodiments, one or more features, components or functionalities of the initialization device may be incorporated within the ECU. For example, the ECU may include a display that may show a user interface. A user may be capable of interacting directly with the ECU. The user may provide a user selection (e.g., of a compensation scheme) directly to the ECU. Any description herein of an action performed by the initialization device may be performed by the ECU. For example, the ECU may comprise a communication unit that may be capable of communication with remote devices, such as servers, databases, and/or information provided on a cloud-computing based infrastructure. Two-way communications may be provided. Such communications may occur directly or over a network. Such communications may be wired or wireless. The ECU may be able to communicate with one or more filling stations, for example, over a network, such as a telecommunications network (e.g., a cell phone or data network). In some embodiments, the ECU may communicate with one or more other ECUs. A network of ECUs may have a hierarchical structure (e.g., a parent or master ECU may communicate with one or more child or slave ECUs).

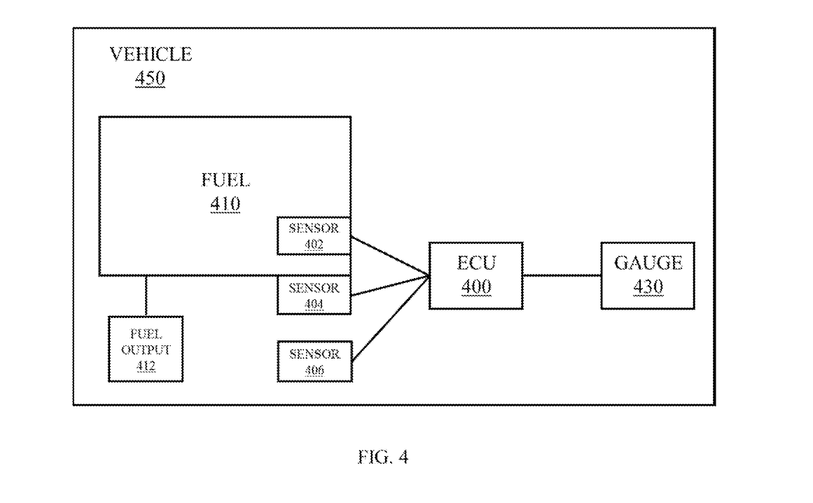

FIG. 4 shows an example of an ECU 400 within a vehicle 450, provided in accordance with an embodiment of the invention. The ECU may be mounted on the vehicle or within the vehicle. The ECU may travel with the vehicle. The vehicle 450 may be any type of vehicle known in the art (e.g., as described elsewhere herein). The same ECU may be capable of interacting with various vehicles or types of vehicle. For example, an ECU may be mounted onto a dump truck, and the same ECU may be capable of being mounted on a bus.

In some embodiments, the vehicle 450 may contain a single gaseous fuel containing device, such as a tank 410 (e.g., a fuel tank or gaseous fuel containing device). In other embodiments, the vehicle may contain a plurality of tanks. The tanks may or may not have the same characteristics. The gaseous fuel containing device 410 may have one or more fuel outputs 412. The fuel output(s) may transfer the fuel to another part of the vehicle 450, such as an engine. In one example, the fuel may be output to mix with air in the cylinder of an engine. The fuel may be used in the process of propelling the vehicle. In some embodiments, the conditions of a single tank or the fuel within the tank may be monitored by a single ECU 400. Alternatively, the conditions of a plurality of tanks or the fuel within the tanks may be monitored by a single ECU. Alternatively, a plurality of ECUs may be used to monitor a single tank (and/or fuel within the tank), or a plurality of tanks (and/or fuel within the tanks).

The ECU 400 may receive signals from one or more sensors 402, 404, 406. The sensors may be within the tank 410, attached to a tank 410, and/or separate from the tank 410. In some examples, a temperature sensor within a tank may capture the temperature of the fuel within the tank. A pressure sensor within a tank may capture the pressure of the fuel within the tank. A temperature sensor attached to the tank may capture the temperature of the tank. The temperature sensor separate from the tank may capture ambient conditions around the tank and/or the temperature of one or more plumbing lines. Any number or combination of such sensors may be used. Any number of sensors or combinations of such sensors (e.g., temperature, pressure and/or flow sensors) may be used for a single tank, or for a plurality of tanks. In embodiments with multiple tanks gaseous fuel containing devices (e.g., tanks), one or more sensors (e.g., temperature, pressure and/or flow sensors) may be provided per each gaseous fuel containing device. For example, a first set of temperature, pressure and flow sensors may be provided to monitor temperature/pressure/flow of a first tank, and a second set of temperature, pressure and flow sensors may be provided to monitor temperature/pressure/flow of a second tank. Any aspects of the disclosure described in relation to sensors for fuel tanks may equally apply to sensors used anywhere in the fuel system (e.g., anywhere in the fuel system 110), in other vehicle system(s) and/or in a local or surrounding environment at least in some configurations. For example, the ECU may be in communication with temperature, pressure and/or flow sensors in and/or on one or more tanks, fuel management components present in the fuel system, fuel control components along plumbing lines and/or with one or more ambient temperature or pressure sensors. In some embodiments, the sensors may be dynamic sensors. For example, dynamic temperature sensors may dynamically provide the ECU with the temperature of the gas in the one or more tanks, fuel management components, along plumbing lines and/or the outside air temperature. Such sensors may enable more accurate gauge readings (e.g., the gauge readings can have better time resolution). Flow sensors (e.g., venturi, a choked flow orifice coupled with stagnation temperature and pressure sensors, etc.) may provide mass flow rate, molar flow rate, or other flow measurement values or signals. In some cases, flow measurements may be provided dynamically. In some cases, flow sensors may detect or measure binary values (e.g., whether flow is on or off).

The ECU 400 may communicate one or more commands to a gauge 430. Each command may be provided directly or indirectly to the gauge. One or more additional devices may be provided which may convert the proper signal for the gauge. The command to the gauge may be generated based on the signals from one or more of the sensors. For example, the gauge may display a level of fuel. The level of fuel may be for a single tank. The level of fuel may be the overall fuel within the vehicle, which may be distributed over one or more tanks. Alternatively, the level of fuel may be shown separately for each tank of the vehicle. In one example, the gauge may be display the fuel level on a dashboard of the vehicle.

The ECU may be capable of communicating with various types of sensors and/or gauges. The ECU may be able to compensate for different characteristics of sensors and/or gauges. The ECU may be initialized to operate with a particular set of sensors and/or gauges. The ECU may be re-initialized and/or programmed to operate with a different set of sensors and/or gauges. A user may select characteristics or parameters of the various sensors and/or gauges, thereby enabling the ECU to interact and provide an accurate reading (e.g., fuel level reading) for the sensors and/or gauges. In some instances, the characteristics or parameters of the various sensors and/or gauges may be automatically detected and updated when the ECU is placed into communication with the sensors and/or gauges.

The ECU may be connected to the vehicle and may provide communication with one or more portions of the vehicle. For example, the ECU may be electrically communicating with a sensor of the vehicle. The ECU may be electrically communicating with a gauge of the vehicle. In some examples, the ECU may be electrically connected to a sensor of the vehicle and electrically connected to a gauge of the vehicle, electrically connected to the sensor without being electrically connected to the gauge, electrically connected to the gauge without being electrically connected to the sensor, or not electrically connected to the sensor and not electrically connected to the gauge. The ECU may be electrically connected to the vehicle and may or may not receive power from the vehicle. The ECU may be able to adapt for different sensors and/or gauges.

In some embodiments, calculations and/or processing performed by the ECU may be based on a set of received signals and/or stored data. For example, a filling compensation scheme may be selected from a plurality of filling compensation schemes. The filling compensation scheme may be used to provide a filling compensation when filling the tank with fuel, or after the vehicle has been fueled and is in operation. Examples of possible filling compensation schemes may include none (e.g., no special correction measurements), temperature-based compensation (e.g., gas pressure compensation based on ambient temperature to determine final resting pressure after gas cools, final resting pressure determination throughout filling process based on dynamic temperature measurements), fuel-based compensation (e.g., compensation based on filling speed and keeping maximum pressure and reducing it by fuel consumption up to threshold pressure), or time-based compensation (e.g., compensation based on filling and reducing the pressure by the time when the key is on). In some cases, the filling compensation schemes may be utilized to fill the tanks such that fuel capacity in the tanks is increased (e.g., by initially filling the tanks to a higher pressure, such that a resting pressure closer to a maximum allowable system pressure is achieved), thus extending the range of driving until the next refueling.

In some embodiments, a compensation scheme may include using an ideal gas law to determine the amount of fuel in a tank. Logic may be provided that may include non-linear compressibility of gas. One or more other algorithm or calculation may also be performed to determine the amount of fuel in a tank. In some instances, ambient temperature may be a factor that may be used with preset logic to determine the output signal to the gauge. A look-up table or other records may be used for gauge linearity correction. Alternatively, gain setting using interpolation may be used. In some instances, a look-up table is not used for determining an output signal to a gauge. Using calculations based on physical principles may advantageously not require the type of calibration that a look-up table would. For example, utilization of algorithms may not need special calibration since it is based on the relationship between amount of gas, temperature and pressure that may remain true. The use of look-up tables instead of such calculations may require look-up tables for every particular tank, sensor and maximum pressure by experiment. In some instances, a D/A (digital to analog) converter may be implemented using switched resistors. Such techniques may or may not be utilizing complex components. Such techniques may provide a result to derive resistor gauges.

Setting up a fuel gauge may also include selecting transfer function specifications. Setting up a transfer function specification may include receiving one or more input from a user, and/or permitting automated detection of one or more value. Such specifications may reflect characteristics and/or parameters for gauges, and/or other settings for compensation schemes and/or alerts for the vehicle. Selecting sensor specifications may include receiving one or more input from a user and/or permitting automated detection of one or more value. Such specifications may reflect characteristics and/or parameters for sensors. Selecting a service cycle may permit an input from a user. The user may input a desired number of filling cycles to be completed before providing an alert for a service.

A user may be able to define a number of cycles of filling after which the ECU may alert an operator of the vehicle to service the vehicle. A user may define the number of service cycles by entering a value and selecting a “write” option. A user may select a “read” function to see the current cycle. A user may select a “reset” option to reset the count after performing a service. For example, a user may define that after 50 filling cycles, the operator should get the vehicle serviced. Any type of visual display of the current filling cycle may be provided, to show how far along the vehicle is in the process. An alert to the vehicle operator may include a blinking light, audio alert, or any other type of alert. In one example, an alert may be provided through the low fuel warning lamp, but may blink at a specified rate. For example, the low fuel warning lamp may show a steady light when the fuel level in the tank is low, may blink at a first rate when a leak is detected based on pressure drop, and may blink at a second rate when the time for service has arrived, or any combination thereof.

Based on input from one or more sensor, and/or a selected compensation (or other) scheme, a gauge command may be determined. The gauge command may be determined by the ECU. The ECU may receive input from one or more sensors. For example, an ECU may receive information from a pressure sensor, capable of measuring pressure within a fuel tank, a temperature sensor capable of measuring temperature of gaseous fuel within a fuel tank, and/or an ambient temperature sensor, capable of measuring ambient temperature. The ECU may receive information from sensors for a single tank, or from multiple tanks. The ECU may have received an input for a selected filling compensation scheme. The ECU may have received the compensation scheme prior to operation of the vehicle. The ECU may have a selected compensation scheme stored therein. The selected compensation scheme may be stored in a memory of the ECU. The compensation scheme may include one or more algorithm or instructions for providing a gauge command. The ECU may perform one or more calculations in accordance with the compensation (or other) scheme. The calculations may incorporate one or more sensor values. The gauge command may be determined based on the one or more calculations. For example, a gauge pressure may be calculated. Based on the calculated gauge pressure, one or more gauge commands may be provided to the gauge. Examples of gauge commands may include one or more voltage value provided to a gauge, and/or any other signals provided to the gauge.

In some embodiments, a gauge command may not be provided, or a gauge may not display a parameter displayed when the vehicle is not in operation (e.g., the fuel level is not displayed when the vehicle is not in operation). Alternatively, the parameter (e.g., the fuel level) may be displayed when the vehicle is not in operation.

One or more alerts may be provided to an operator of the vehicle. The alert may be provided while the vehicle is in operation. In some instances, an alert may be provided even when a vehicle is not in operation. For example, an alert may be provided when the fuel is low. This may be detected when a pressure drops below a threshold value. The ECU may receive the sensor signal for pressure and may or may not compensate based on one or more compensation schemes. The ECU may have a threshold value, and may determine whether the pressure of the fuel has dropped below the threshold. Another example of an alert may be when a leak is detected. A leak may be detected when a rate of pressure decrease exceeds a leakage threshold. For example, if the pressure drops by more than a certain pressure unit/time unit (e.g., psi/hour), this may indicate a leak and/or an alert may be provided. In some instances, different leakage thresholds may be provided for when a vehicle is in operation (leakage on threshold) and for when a vehicle is not in operation (leakage off threshold). In some instances, during vehicle operation, some pressure decrease may be expected as fuel is consumed. The leakage on threshold may be higher than the leakage off threshold to compensate for the expected pressure drop in fuel when the vehicle is in operation. For example, a leakage on value may be about 1500 psi/hour while a leakage off value may be about 150 psi/hour. Alternatively, the same value may be provided as a leakage threshold, regardless of whether the vehicle is or is not in operation. Further, an alert may optionally be provided when a threshold number of filling cycles have been completed for the vehicle. The alert may be provided to the operator of the vehicle to get the vehicle serviced. For example, a selected number of filling cycles (filling the vehicle with fuel) may be selected.

In some embodiments, the ECU may determine when one or more filters (e.g., on the vehicle engine, on one or more fuel management components present in the fuel system, etc.) may need to be replaced or serviced. The ECU may notify the vehicle computer, the driver, or other on-board system. For example, the ECU may communicate filter changes to one or more gauges described herein, such as a vehicle dashboard. In another example, the ECU may cause a warning lamp to turn on to indicate that a filter change is needed. In some examples, the ECU may communicate with one or more controls on the vehicle, such as a valve that may allow a flow path with a used filter to be bypassed. The ECU may communicate the need for filter service externally to a filling station, central server, or fleet management software. Filter monitoring may be accomplished by various means including, but not limited to, providing pressure sensors before and after the filter in a flow path comprising the filter and measuring the difference in pressure, keeping a log of the amount of fuel that has passed through the filter, or by counting the number of fillings.

In some embodiments, one or more fuel tanks or gaseous fuel containing devices may be provided on the vehicle. When more than one tank is provided, one or more of the tanks may be controlled by the ECU to enable staged fuel delivery of the fuel stored in the tanks. For example, the ECU may control one or more electronic solenoid valves. The ECU may receive data from one or more pressure/temperature sensors. These solenoid valves and pressure/temperature sensors may be provided, for example, on a neck of each tank, on one tank (e.g., on the body, or on the neck), on a combination of tanks (e.g., on two of a plurality of tanks, on all tanks, etc.), or elsewhere in the system. For example, with solenoid valves and pressure/temperature sensors on the neck of each tank, the ECU may close some tanks off and keep others open during operation. Tanks may be actively opened, actively closed, kept open or kept closed by the ECU. In some cases, one or more solenoid valves may be provided separately from one or more pressure/temperature sensors on each tank. Some tanks may have either solenoid valve(s), or pressure/temperature sensor(s). In some cases, a majority of tanks may have pressure/temperature sensor(s), while only some tanks may have solenoid valve(s). Alternatively, solenoid valve(s) may be provided on all tanks, but only a subset of the valve(s) may be controlled by the ECU for staged fuel delivery. Each tank may have one or more of a solenoid valve, a pressure sensor or a temperature sensor.

In some embodiments of a multiple tank system, the tanks may be used one tank at a time. For example, one tank may be used only for starting or cranking, and the rest of the tanks may be used for driving operation. In this configuration, one tank or a subset of tanks may be maintained at high pressure, which may prevent the previously described issues with low pressure starting. Alternatively, fuel may be consumed from one tank or a subset of tanks at a time. The ECU enables switching between tanks at any time during operation. Similarly, the ECU, if utilized during filling, may also enable controlled filling of the tanks. For example, tanks may not need to be accessed one at a time, but a unified fuel inlet controlled by the ECU may be used to fill all tanks. In some cases, tanks may be filled or drained according to a predefined schedule or settings. The predefined schedule or settings may be set by the user, automatically controlled by the ECU, or a combination thereof.

Alternatively, staged fuel delivery (e.g., to or from a fuel tank) may be implemented using mechanically controlled valves and/or switch mechanisms (e.g., mechanical switches described in relation to FIGS. 2A-2C).

By utilizing the tanks in a staged configuration, it may be possible to save time and/or energy refueling if the tanks are not completely drained. For example, if there is a five tank system, the tanks were being consumed sequentially and only two of the five tanks have been drained, then the station may only need to fill two tanks up to full pressure. Staged fuel delivery may also be used to improve the quality of fill (also “filling” herein) by, for example, altering the amount of time during the fill that fuel (e.g., cold gas) is being entered into the tank (e.g., via the Joule Thomson process). For example, the fuel (e.g., natural gas) may have a positive Joule-Thomson coefficient. Due to the Joule-Thomson effect, the fuel may cool upon entry into the tank (e.g., through a tank valve) and heat up inside the tank as the tank fills. In some cases, the duration of filling of an individual tank may be configured such that heat of compression in the tank is kept below a given threshold or within a given range. For example, when the heat of compression in the tank reaches a given value, the system may switch to a different tank. In some cases, the duration of filling of each tank in a set of tanks may be configured such that heat of compression in the set of tanks is kept below a given threshold or within a given range (e.g., such that the heat of compression is kept within a given range in all tanks). In some cases, the duration of filling of an individual tank (or a set of tank) may be configured such that temperature in the tank (or the set of tanks) is kept below a given threshold or within a given range. For example, the temperature (or other parameter, such as pressure, stress/strain, etc.) may have a temporal profile during filling. The fill process may comprise regions during which filling is more efficient (e.g., corresponding to a given region of the temporal profile). In some cases, the filling process may be allowed to proceed as long as the filling process remains within the given region of the temporal profile before switching over to another fuel tank. In some cases, the tanks may be emptied such that, during subsequent filling, the filling process is commenced within the given region of the temporal profile. In some cases, staged fuel filling may be a function of the pressure or flow rate capacity of the fuel source (e.g., filling station).

The ECU may further control high and low pressure fuel paths provided on one or more of a plurality of tanks during staged fuel delivery. For example, high and low pressure fuel paths may be provided on each tank. Alternatively, for example when some tanks are used only for high pressure operation during starting and some tanks are used only for variable pressure operation during driving, the starting tanks may only be provided with a high pressure path, while the driving tanks may be provided with the high pressure and low pressure paths. Each tank may have one or more of a solenoid valve, a pressure sensor or a temperature sensor. Alternatively, the tanks may share one or more sensors and/or solenoid valves. The sensors, solenoid valves and/or other tank components may be individually controlled by the ECU. Alternatively, the ECU may simultaneously control groups of sensors, solenoid valves and/or other tank components on multiple tanks.

In some embodiments, one or more kill caps may be provided. If a specified operational condition is detected, a starter interrupt circuit may prevent a vehicle from being started. For example, during a filling procedure while a fuel dispenser is connected to a vehicle receptacle (e.g., fluidically connected to a vehicle tank), the starter interrupt logic may cause the one or more kill caps to kill a connection, preventing the starting the vehicle. The kill caps may be switches that may kill the connection. For example, if a driver of the vehicle were to forget to disconnect the dispenser and drive the vehicle, an explosion may occur. However, with the kill caps safety mechanism, the driver may not be able to start the engine while the fuel dispenser is connected to the vehicle (e.g., like pressing the clutch pedal to start a standard transmission vehicle). The starter interrupt may be controlled without the use of relays, which can create voltage spikes in the electrical system. In some embodiments, a plurality of kill switches may be provided. For example, three or more kill switches may be provided. The kill switches may be provided at different points or locations of the vehicle. One kill switch may be provided to check a dust cap on a vehicle receptacle. Another kill switch may be provided at the vehicle receptacle. Another kill switch may be provided for a fill panel door.

In some embodiments, the ECU may monitor the life of one or more gaseous fuel containing devices (fuel tanks) on a vehicle. The ECU may be able to determine when a fuel tank (e.g., gaseous fuel containing device) will need to be replaced or serviced. The ECU may notify a vehicle computer, driver (e.g., via a gauge, dashboard, or warning lamp) or other on board system or entity described herein. The ECU may communicate the need for tank service externally to a filling station, a central server, fleet management software, or other external entity described herein.

In some cases, the life of the tank and/or the amount of time between tank inspections may be a fixed number of years. This may not take into account the amount of stress and/or the type of stress that the tank has been subjected to over its lifetime. The determination of tank life may be improved by utilizing one or more sensors on the tank, including, but not limited to, pressure, temperature, strain, acceleration, proximity, reed switch and/or light sensors. The sensors may be in communication with the ECU and may transmit data to the ECU. The data from the sensors may be logged with a time stamp. Using the time stamped sensor data, the amount of stress each tank has been under may be determined using various models. The stress calculation may be executed on board (e.g., by the ECU), on a central server or other remote information system or device (e.g., by sending the collected data by any of the communication means described herein), or a combination thereof. Using the amount of stress that the tank has been exposed to over its lifetime may provide a more accurate measure for determining when the next service should be and/or the overall lifespan of each tank in the system.

The sensor data, the calculated stress, the determination of the tank life and/or other associated data may be transmitted to a filling station in order to prevent filling of a tank that may not be in a condition to be filled. For example, the data may be communicated to the filling station in order to prevent the filling of an uninspected tank (e.g., a tank for which damage or stress was detected, and which may need to be inspected and/or replaced before being fit for service). The data may be communicated, for example, from the ECU or from the remote information system or device on which the stress and/or tank life calculation was executed.

Embodiments of the invention may include electronic witness systems. The ECU may observe the current state of the fuel and/or vehicle system, for example via one or more sensors, and may communicate the system status to the driver, the vehicle, fleet software, a filling station, or any other on board or external entity described herein. The status of the system may include, for example, preventative maintenance information, real-time electronic witness data, or other system data. The electronic witness data may include, but is not limited to, tank or body cover damage detection, temperature and pressure data, data from strain gauges and data from a G-ball or other acceleration sensor.

In some cases, the ECU may be able to detect if damage was done to a tank or body cover from a very thin conductive inlay into the body cover panels. If the circuit of the conductive inlay is broken, the ECU may communicate to the vehicle, the driver, fleet software, a filling station, or any other on board or external entity described herein that damage has been done to a body cover. Communication of the electronic witness data may ensure timely inspection of the damage. The electronic witness systems may be provided on one or more tanks, on one or more tank covers, or elsewhere within the vehicle. The electronic witness functionality may not be limited to the vehicle fuel system. For example, the electronic witness functionality may be applied on an engine cylinder, on the vehicle chassis, or in other locations on the vehicle.

The electronic witness functionality may include communication of the ECU with strain gauges or other sensors on critical components that can determine damage or stress on the critical components. The ECU may use pressure and temperature data to determine if there was a fire or an accident. In the case of a fire or an accident, the ECU may notify one or more entities described in more detail elsewhere herein that a tank service or an inspection is needed. The ECU may communicate with a G-ball or other acceleration sensor that can determine if an accident has occurred. In response, the ECU may adjust vehicle operation by, for example, turning off electronic solenoids at tanks to prevent fuel loss. In another example, the ECU may notify a station, a driver or any other entity described herein that an inspection is necessary before the next refueling. The ECU may activate an alarm (e.g., an alarm on a gauge or a dashboard, a warning lamp) when triggered one or more electronic witness systems. Alternatively, or additionally, the ECU may notify a fleet service provider or fleet manager during minor (non-critical) events.

The electronic witness functionality may interact with one or more functionality in accordance with the present disclosure. For example, an electronic witness system on a fuel tank or body cover may communicate with the ECU that damage has occurred, The ECU may then communicate with, for example, an ignition disconnect or kill switch system to switch off ignition. In some cases, as described in greater detail with reference to FIG. 5, the electronic witness system may communicate directly with the ignition disconnect system or with any other entity in communication with the ECU or otherwise provided on the vehicle.

FIG. 5 shows examples of entities with which an ECU 500 may communicate. Such entities include one or more sensors 501 (e.g., temperature sensors, pressure sensors, electronic witness sensors or any other sensors described herein), one or more gauges 502 (e.g., readouts, including mechanical needle readouts, user interfaces, indicator lamp, vehicle dashboard or any other gauges or indicators described herein), one or more controls 505 (e.g., kill switches or kill caps, valves, tanks or tank components, tank or body covers or components thereof, or any other controls described herein), one or more ECUs 504 (e.g., ECU associated with a kill cap or a body tank/body cover, ECU associated with engine manifold, or any other ECUs described herein), and/or one or more devices or information systems hosted on devices 503 (e.g., initialization device, server, cloud, filling station, fleet management software, or any other device or information system hosted on a device described herein). Any of the entities in communication with the ECU may utilize communication types and interfaces described herein. The entities with which the ECU interacts may interact with each other. In some examples, one or more of the entities may interact with the ECU by proxy (e.g., via another entity). Further, one or more entities such as an electronic witness may function both as a sensor and as a control. For example, in some cases, an electronic witness component may communicate data or information to the ECU. In other cases, or additionally, the ECU may provide instructions or send data to the electronic witness component (e.g., the ECU may trigger an electronic witness circuit in response to an event elsewhere in the system that was communicated to the ECU). Further variations include functionality of a control system as a gauge, and so on. One or more entities may be located on board the vehicle (e.g., gauges, sensors, controls, other ECUs).

One or more entities may be located externally to the vehicle (e.g., gauges, devices). For example, a filling station is external to the vehicle and may be in communication with the vehicle's ECU. In some examples, sensors or controls may also be located externally to the vehicle, such as, for example, an external sensor in communication (e.g., wirelessly) with the ECU during filling, or an external control (e.g., fuel pump) in communication with the ECU during filling, etc. Thus, the entities in FIG. 5 may communicate with the ECU, with each other, interchangeable and/or by proxy. The entities in FIG. 5 may be located on the vehicle or externally to the vehicle.

The ECU may communicate with other devices, sensors, gauges, ECUs, and the vehicle (including components/systems and controls on board the vehicle). The ECU may communicate to other electronic devices and sensors both on the vehicle and to external servers, devices, filling/fueling stations and/or other entities using one or more communication protocols and via one or more type of connection. For example, the ECU may communicate using either passive or active RFID, Wi-Fi, Blue Tooth, or other wireless communication methods, or over a direct wire connection such as, for example, USB, Ethernet, Firewire, serial, or single wire, etc. The ECU may send and receive data to and from the ECU using the CAN protocol or other vehicle communication protocol, or to external computers, servers, or devices using a number of communication protocols including, for example, TCP/IP, serial, USB, or other communication method. The ECU may also receive inputs from the vehicle, such as, for example, speed, distance traveled, amount of time injector was open, fuel consumption, etc. The ECU may communicate data or signals to fueling station, the vehicle dashboard or other devices or information systems hosted on devices. In some embodiments, the ECU may be able to communicate or partially communicate while the vehicle is turned off (e.g., filling). Power to the ECU during such operation may be supplied, for example, from one or more auxiliary power sources on board the vehicle (e.g., a battery) or one or more power sources external to the vehicle in electronic communication with the ECU and/or the vehicle via a wired or wireless power connection.

The ECU may log all data from all systems on board the vehicle. The ECU may communicate with all systems on board the vehicle. The ECU may communicate with systems external to the vehicle. Examples of data transmitted may include the vehicle identification number (VIN), license plate, vehicle model, tank configuration, number of tanks, fleet vehicle number, system serial number, system status, number of fill cycles, mileage, fuel utilization, filter service and tank service data, sensor data, temperature data, or any other data that has been collected or observed. Diagnostics may be communicated to and from the ECU (e.g., via the CAN protocol) and integrated into the vehicle's error codes. These error codes may be transmitted to external electronics, fleet software, servers, the driver, etc.

Vehicle data collected in other systems (e.g., other ECUs or controls), such as, for example, speed or distance traveled, may be sent to the ECU and used in calculations along with data the ECU collects via its sensors or other communication channels. These calculations may include, but are not limited to, average fuel consumption per mile, instantaneous fuel consumption, total range left before the next refueling, etc.

The transmitted data may be uploaded to fleet tracking software for easy integration into vehicle maintenance tracking, fuel consumption tracking, vehicle fuel efficiency tracking in miles per gallon Diesel equivalent (MPGDe), vehicle efficiency tracking in cost per mile ($/mile), and/or other parameters. Service data (e.g., filter changes, tank life data, damage detected by electronic witness systems) may be sent to a central server where replacement parts can be purchased and service or warranty requests can be sent. The warranty and/or service requests may be sent along with data that has been logged while the problem was occurring, thus enabling fast diagnosis. In some examples, autonomous diagnosis may be enabled.

In some embodiments, the ECU may enable data logging and acquisition. The ECU may collect data from various sensors and store the data with a timestamp of when the data was collected. The data may be processed on board (e.g., by the ECU), on a central server in communication with the ECU after it has been transmitted via methods discussed earlier, or a combination thereof. The data may be stored in memory and/or transmitted in either a compressed or raw data form. The data may take the form of aggregate data to minimize memory storage size. The data may be raw data from all sensors. The data may be able to be streamed in real time and observed on either a display inside the vehicle, on a computer or display directly connected to the ECU, on a computer or display in remote communication with the ECU or via any other communication/connection method described herein.

Systems and methods of the disclosure may be combined with or modified by other systems, and/or methods, such as control units, fuel systems and kill switches described in U.S. Patent Application Publication No. 2013/0197777 (“SYSTEMS AND METHODS FOR MONITORING AND CONTROLLING FUEL SYSTEMS”), and U.S. Patent Application Publication No. 2013/0291825 (“IGNITION DISCONNECT”), which are entirely incorporated herein by reference.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for operating a fuel system on a vehicle, the method comprising:
providing the fuel system, wherein the fuel system comprises:
a gaseous fuel containing device of the vehicle;
a fuel flow path from the gaseous fuel containing device to an engine of the vehicle, wherein the fuel flow path is configured to deliver a fuel from the gaseous fuel containing device to the engine, and wherein the fuel flow path comprises a pressure regulator and an alternative fuel flow path for bypassing the pressure regulator; and
opening the alternative fuel flow path below a predetermined fuel pressure, thereby bypassing the pressure regulator.

2. The method of claim 1, further comprising closing the alternative fuel flow path when the pressure of the fuel is above the predetermined fuel pressure.

3. The method of claim 2, further comprising alternately opening and closing the alternative fuel flow path, thereby switching between the pressure regulator and the alternative fuel flow path.

4. The method of claim 3, wherein the switching is mechanically controlled.

5. The method of claim 3, wherein the switching is electronically controlled.

6. The method of claim 3, wherein the switching is controlled by an electronic control unit in communication with one or more sensors that measure the fuel pressure.

7. The method of claim 1, wherein the predetermined fuel pressure is a predetermined inlet pressure of the fuel flowing to the pressure regulator.

8. The method of claim 1, wherein the alternative fuel flow path comprises a valve or flow control component.

9. The method of claim 8, further comprising automatically opening the valve or flow control component below the predetermined inlet pressure.

10. The method of claim 1, further comprising mechanically actuating the opening of the alternative fuel flow path.

11. A system for regulating gaseous fuel delivery on a vehicle, the system comprising:
a container that holds a volume of gaseous fuel;
one or more fuel transfer lines that transfer at least a fraction of the volume of gaseous fuel from the container to a regulator bypass assembly comprising (1) a regulator flow path having a regulator and (2) a bypass flow path by passing the pressure regulator; and
an actuator configured to variably control flow of gaseous fuel via the one or more fuel transfer lines through (1) the regulator flow path, (2) the bypass flow path, or (3) any combination thereof, based on one or more flow parameters while the vehicle is operating.

12. The system of claim 11, wherein the actuator senses the one or more flow parameters implicitly with a mechanical actuator that passively responds to the one or more flow parameters.

13. The system of claim 11, wherein the actuator senses the one or more flow parameters based on a measurement from one or more sensors configured to measure the one or more flow parameters.

14. The system of claim 11, wherein the one or more flow parameters includes inlet pressure of fuel flowing to the pressure regulator.

15. A method of switching a vehicle from a first operating state to a second operating state, the method comprising:
providing a fuel system, wherein the fuel system comprises:
a gaseous fuel containing device of the vehicle;
a fuel flow path from the gaseous fuel containing device to an engine of the vehicle, wherein the fuel flow path is configured to deliver a fuel from the gaseous fuel containing device to the engine, and wherein the fuel flow path comprises (1) a first fuel flow path configured to deliver fuel to the engine at or above a predetermined fuel pressure and (2) a second fuel flow path configured to deliver fuel to the engine below the predetermined fuel pressure;
delivering the fuel to the engine through either of the first fuel flow path or the second fuel flow path; and
switching a flow of the fuel from the first fuel flow path to the second fuel flow path or vice versa while the vehicle is operating.

16. The method of claim 15, wherein the switching is mechanically controlled.

17. The method of claim 15, wherein the switching is electronically controlled.

18. The method of claim 15, wherein the switching is controlled by an electronic control unit in communication with one or more sensors that measure the fuel pressure.
